(19) United States
(12) Patent Application Publication
(10) Pub. No.: US 2009/0096586 A1
(43) Pub. Date: Apr. 16, 2009

(54) Radiofrequency Tracking and Communication Device and Method for Operating the Same

(75) Inventor: Earl Fred Tubb, Santa Cruz, CA (US)

Correspondence Address: MARTINE PENILLA & GENCARELLA, LLP, 710 LAKEWAY DRIVE, SUITE 200, SUNNYVALE, CA, 94085, US

(73) Assignee: iControl, Inc., Santa Clara, CA (US)

(21) Appl. No.: 12/249,932

(22) Filed: Oct. 12, 2008

Related U.S. Application Data
(60) Provisional application No. 60/979,394, filed on Oct. 12, 2007.

(51) Int. Cl. H04Q 5/22

(52) U.S. Cl. 340/10.33; 340/10.1

(57) ABSTRACT

A radio is defined in electrical communication with a processor on an integrated circuit chip. The radio is defined to operate at an international frequency, and is defined to be powered on and off in accordance with a control signal to be transmitted by the processor. A location determination device is defined to electrically communicate with the processor. The location determination device is also defined to be powered on and off in accordance with a control signal to be transmitted by the processor. A power source is defined to supply power to the processor, the radio, and the location determination device. The processor, radio, location determination device, and power source are integrated together in a portable device that can be affixed to a moveable asset. A power management program is implemented to enable long-term deployment of the portable device without replacement of the power source.

### CLAIM OF PRIORITY

This application claims priority under 35 U.S.C. 119(e) to U.S. Provisional Patent Application No. 60/979,394, filed Oct. 12, 2007, entitled “Ultra-Long Range Active GPS RF Tag.” The disclosure of the above-identified provisional patent application is incorporated herein by reference.

### GOVERNMENT LICENSE RIGHTS

The U.S. Government has a paid-up license in this invention and the right in limited circumstances to require the patent owner to license others on reasonable terms as provided for by the terms of Contract No. HSHQDC-07-C-00017, awarded by U.S. Department of Homeland Security, Science and Technology Directorate.

### BACKGROUND

In modern global commerce, it is becoming more important than ever to have an ability to track and monitor assets as they move about the world. Additionally, government institutions may have an interest in knowing the current location of a particular asset, and in having an accurate and reliable historical record of where a particular asset has been. A maritime transport container represents one of many examples of an asset to be tracked and monitored as it travels around the world. Information about a particular asset, such as its current location, where it has traveled, how long it spent in particular locations along its route, and what conditions it was exposed to along its route, can be very important information to both commercial and governmental entities. To this end, a device is needed to track and monitor an asset anywhere in the world, and to collect and convey information relevant to the asset's experience during its travels.

### SUMMARY

In one embodiment, a radiofrequency tracking and communication device (TAG device) is disclosed. The TAG device includes a processor defined on a chip. The TAG device also includes a radio defined on the chip to electrically communicate with the processor. The radio is defined to operate at an international frequency. The radio is also defined to be powered on and off in accordance with a control signal to be transmitted by the processor. The TAG device further includes a location determination device defined to electrically communicate with the processor. The location determination device is defined to be powered on and off in accordance with a control signal to be transmitted by the processor. Additionally, the TAG device includes a power source defined to supply power to the processor, the radio, and the location determination device.

In another embodiment, a radiofrequency tracking and communication device (TAG device) is disclosed. The TAG device includes a processor defined on a chip. The TAG device also includes a radio defined on the chip to electrically communicate with the processor. The radio is defined in compliance with an Institute of Electrical and Electronics Engineers (IEEE) 802.15.4 standard. The TAG device further includes a global positioning system (GPS) receiving device defined to electrically communicate with the processor. The TAG device also includes a power source defined to supply power to the processor, the radio, and the GPS receiving device.

In another embodiment, a method is disclosed for operating a radiofrequency tracking and communication device (TAG device). The method includes an operation for maintaining a minimum power consumption state of the TAG device until issuance of a wakeup signal. The method also includes operating a motion sensor during the minimum power consumption state of the TAG device. The method further includes an operation for identifying detection by the motion sensor of a threshold level of movement. In response to identifying the threshold level of movement, the method includes an operation for issuing the wakeup signal to transition from the minimum power consumption state to a normal operating power consumption state of the TAG device.

Other aspects and advantages of the invention will become more apparent from the following detailed description, taken in conjunction with the accompanying drawings, illustrating by way of example the present invention.

### BRIEF DESCRIPTION OF THE DRAWINGS

FIG. 1 is an illustration showing a radiofrequency tracking and communication device (TAG device), in accordance with one embodiment of the present invention;

FIG. 2 is an illustration showing a schematic of the TAG device of FIG. 1, in accordance with one embodiment of the present invention; and

FIG. 3 is an illustration showing a flowchart of a method for operating a TAG device, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

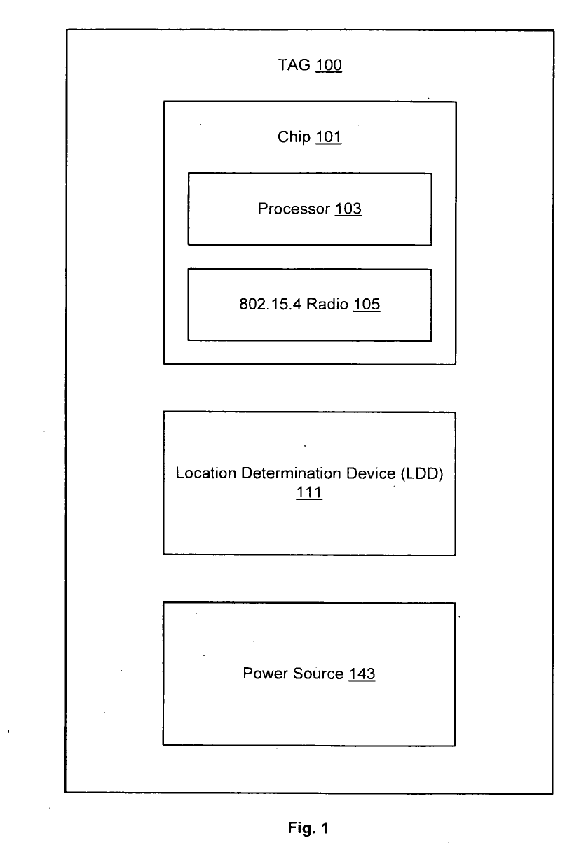

FIG. 1 is an illustration showing a radiofrequency (RF) tracking and communication device 100, in accordance with one embodiment of the present invention. The RF tracking and communication device 100 is referred to as TAG 100 hereafter. The TAG 100 includes a processor 103 defined on a chip 101. The TAG 100 also includes a radio 105 defined on the chip 101. The radio 105 operates at an international frequency and is defined to efficiently manage power consumption. In one embodiment, the radio 105 is defined as an Institute of Electrical and Electronics Engineers (IEEE) 802.15.4 compliant radio 105. The radio 105 is connected to electrically communicate with the processor 103. It should be appreciated that implementation of the IEEE 802.15.4 compliant radio 105 provides for international operation and secure communications, as well as efficient power management.

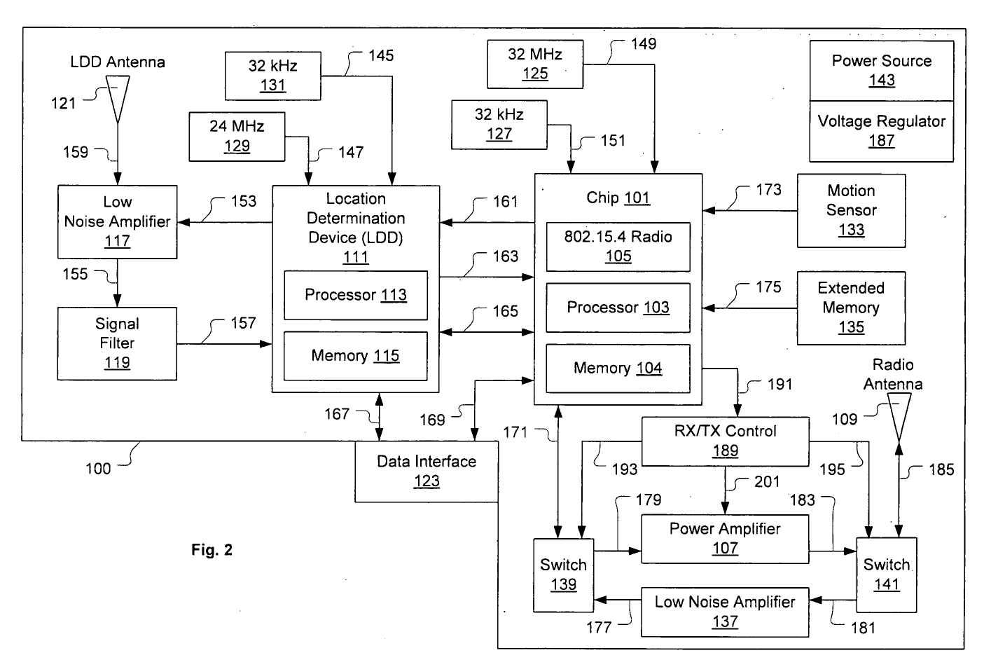

The TAG 100 further includes a location determination device (LDD) 111 defined to electrically communicate with the processor 103 of the chip 101. In one embodiment, the LDD 111 is defined as a Global Positioning System (GPS) receiver device. Additionally, the TAG 100 includes a power source 143 defined to supply power to the processor 103, the radio 105, the LDD 111, and other powered TAG 100 components as described below with regard to FIG. 2. The TAG 100 implements a power management system defined to enable long-term TAG 100 deployment with minimal maintenance. In one embodiment, the power management system is defined to enable TAG 100 operation over a three year deployment period using a single three Volt battery, e.g., 3 Volt D-cell battery.

In one embodiment, the TAG 100 is defined as a self-contained battery operated device capable of being attached to an asset, such as a shipping container, to provide secure tracking and communications associated with movement and status of the asset. In certain embodiments, the TAG 100 may also be configured to provide/perform security applications associated with the asset. Through communication with local and global communication networks, the TAG 100 is capable of communicating data associated with its assigned asset while the asset is in transit, onboard a conveyance means (e.g., ship, truck, train), and in terminal.

As will be appreciated from the following description, the TAG 100 provides complete autonomous location determination and logging of asset position (latitude and longitude) anywhere in the world. The TAG 100 electronics provide an ability to store data associated with location waypoints, security events, and status in a non-volatile memory onboard the TAG 100. The TAG 100 is also defined to support segregation and prioritization of data storage in the non-volatile memory. Communication of commercial and/or security content associated with TAG 100 operation, including data generated by external devices interfaced to the TAG 100, can be virtually and/or physically segregated in the non-volatile memory.

Moreover, in one embodiment, a wireless communication system of the TAG 100 is defined to detect and negotiate network access with network gateways at a range of up to three kilometers (km). The TAG 100 processor 103 is defined to perform all necessary functions to securely authenticate a serial number of the TAG 100, provide encrypted bi-directional communication between the TAG 100 and a reader device within a wireless network, and maintain network connectivity when in range of a network gateway.

Additionally, the TAG 100 is defined to provide an expansion capability for users (both government and commercial) to add additional sensors and/or communication modes of operation. In addition to being secured on a moving asset, the TAG 100 is also defined for use in a handheld reader device and in a network gateway reader device. When disposed in the handheld or network gateway reader device, the TAG 100 provides dual functions of a radio and a GPS beacon. Also, the TAG 100 is defined to implement a proprietary communication protocol to secure and manage data communication between the TAG 100 and network reader devices and to control access to the TAG 100.

In one embodiment, the various components of the TAG 100 are disposed on a printed circuit board, with required electrical connections between the various components made through conductive traces defined within the printed circuit board. In one exemplary embodiment, the printed circuit board of the TAG 100 is a low cost, rigid, four layer, 0.062″ FR-4 dielectric fiberglass substrate. However, it should be understood that in other embodiments, other types of printed circuit boards or assemblies of similar function may be utilized as a platform for support and interconnection of the various TAG 100 components. In one particular embodiment, the chip 101 is defined as a model CC2430-64 chip manufactured by Texas Instruments, and the LDD 111 is implemented as a model GSC3f/LP single chip ASIC manufactured by SiRF.

FIG. 2 is an illustration showing a schematic of the TAG 100 of FIG. 1, in accordance with one embodiment of the present invention. In various exemplary embodiments, the chip 101 that includes both the processor 103 and the radio 105 can be implemented as either of the following chips, among others:

a model CC2430 chip manufactured by Texas Instruments,

a model CC2431 chip manufactured by Texas Instruments,

a model CC2420 chip manufactured by Texas Instruments,

a model MC13211 chip manufactured by Freescale,

a model MC13212 chip manufactured by Freescale, or

a model MC13213 chip manufactured by Freescale.

In each of the above-identified chip 101 embodiments, the radio 105 is defined as an IEEE 802.15.4 compliant radio that operates at a frequency of 2.4 GHz (gigaHertz). It should be understood, that the type of chip 101 may vary in other embodiments, so long as the radio 105 is defined to operate at an international frequency and provide power management capabilities adequate to satisfy TAG 100 operation and deployment requirements. Additionally, the type of chip 101 may vary in other embodiments, so long as the processor 103 serves as the main processor of the TAG 100, and enables communication via the radio 105 implemented onboard the chip 101. Also, the chip 101 includes a memory 104, such as a random access memory (RAM), that is read and write accessible by the processor 103 for storage of data associated with TAG 100 operation.

The TAG 100 also includes a power amplifier 107 and a low noise amplifier (LNA) 137 to improve the communication range of the radio 105. The radio 105 is connected to receive and transmit RF signals through a receive/transmit (RX/TX) switch 139, as indicated by arrow 171. A transmit path for the radio 105 extends from the radio 105 to the switch 139, as indicated by arrow 171, then from the switch 139 to the power amplifier 107, as indicated by arrow 179, then from the power amplifier 107 to another RX/TX switch 141, as indicated by arrow 183, then from the RX/TX switch 141 to a radio antenna 109, as indicated by arrow 185.

A receive path for the radio 105 extends from the radio antenna 109 to the RX/TX switch 141, as indicated by arrow 185, then from the RX/TX switch 141 to the LNA 137, as indicated by arrow 181, then from the LNA 137 to the RX/TX switch 139, as indicated by arrow 177, then from the RX/TX switch 139 to the radio 105, as indicated by arrow 171. The RX/TX switches 139 and 141 are defined to operate cooperatively such that the transmit and receive paths for the radio 105 can be isolated from each other when performing transmission and reception operations, respectively. In other words, the RX/TX switches 139 and 141 can be operated to route RF signals through the power amplifier 107 during transmission, and around the power amplifier 107 during reception. Therefore, the RF power amplifier 107 output can be isolated from the RF input of the radio 105.

In one embodiment, each of the RX/TX switches 139 and 141 is defined as a model HMC174MS8 switch manufactured by Hittite. However, it should be understood that in other embodiments each of the RX/TX switches 139 and 141 can be defined as another type of RF switch so long as it is capable of transitioning between transmit and receive channels in accordance with a control signal. Also, in one embodiment, the power amplifier 107 is defined as a model HMC414MS8 2.4 GHz power amplifier manufactured by Hittite. However, it should be understood that in other embodiments the power amplifier 107 can be defined as another type of amplifier so long as it is capable of processing RF signals for long-range communication and is power manageable in accordance with a control signal. In one embodiment, the power amplifier 107 and RX/TX switches 139 and 141 can be combined into a single device, such as the model CC2591 device manufactured by Texas Instruments by way of example.

The TAG 100 is further equipped with an RX/TX control circuit 189 defined to direct cooperative operation of the RX/TX switches 139 and 141, and to direct power control of the power amplifier 107 and LNA 137. The RX/TX control circuit 189 receives an RX/TX control signal from the chip 101, as indicated by arrow 191. In response to the RX/TX control signal, the RX/TX control circuit 189 transmits respective control signals to the RX/TX switches 139 and 141, as indicated by arrows 193 and 195, respectively, such that continuity is established along either the transmission path or the receive path, as directed by the RX/TX control signal received from the chip 101. Also, in response to the RX/TX control signal, the RX/TX control circuit 189 transmits a power control signal to the power amplifier 107, as indicated by arrow 201. This power control signal directs the power amplifier 107 to power up when the RF transmission path is to be used, and to power down when the RF transmission path is to be idled.

In one embodiment, the LDD 111 includes a processor 113 and a memory 115, such as a RAM, wherein the memory 115 is read and write accessible by the processor 113 for storage of data associated with LDD 111 operation. In one embodiment, the LDD 111 and chip 101 are interfaced together, as indicated by arrow 161, such that the processor 103 of the chip 101 can communicate with the processor 113 of the LDD 111 to enable programming of the LDD 111. In various embodiments, the interface between the LDD 111 and chip 101 may be implemented using a serial port, such as a universal serial bus (USB), conductive traces on the TAG 100 printed circuit board, or essentially any other type of interface suitable for conveyance of digital signals.

Also, in one embodiment, a pin of the LDD 111 is defined for use as an external interrupt pin to enable wakeup of the LDD 111 from a low power mode of operation, i.e., sleep mode. For example, the chip 101 can be connected to the external interrupt pin of the LDD 111 to enable communication of a wakeup signal from the chip 101 to the LDD 111, as indicated by arrow 165. The LDD 111 is further connected to the chip 101 to enable communication of data from the LDD 111 to the chip 101, as indicated by arrow 163.

The LDD 111 is also defined to receive an RF signal, as indicated by arrow 157. The RF signal received by the LDD 111 is transmitted from the LDD antenna 121 to a low noise amplifier (LNA) 117, as indicated by arrow 159. Then, the RF signal is transmitted from the LNA 117 to a signal filter 119, as indicated by arrow 155. Then, the RF signal is transmitted from the filter 119 to the LDD 111, as indicated by arrow 157.

Additionally, in one embodiment, the LDD 111 is defined as a single chip ASIC, including an onboard flash memory 115 and an ARM processor core 113. For example, in various embodiments, the LDD 111 can be implemented as either of the following types of GPS receivers, among others:

a model GSC3f/LP GPS receiver manufactured by SiRF,

a model GSC2f/LP GPS receiver manufactured by SiRF,

a model GSC3e/LP GPS receiver manufactured by SiRF,

a model NX3 GPS receiver manufactured by Nemerix, or

a model NJ030A GPS receiver manufactured by Nemerix.

The LNA 117 and signal filter 119 are provided to amplify and clean the RF signal received from the LDD antenna 121. In one embodiment, the LNA 117 can be implemented as an L-Band device, such as an 18 dBi low noise amplifier. For example, in this embodiment the LNA 117 can be implemented as a model UPC821TK amplifier manufactured by NEC. In another embodiment, the LNA 117 can be implemented as a model BGA615L7 amplifier manufactured by Infineon. Also, the LNA 117 is defined to have a control input for receiving control signals from the LDD 111, as indicated by arrow 153. Correspondingly, the LNA 117 is defined to understand and operate in accordance with the control signals received from the LDD 111. In the embodiment where the LDD 111 is implemented as the model GSC3f/LP GPS receiver by SiRF, a GPIO4 pin on the GSC3f/LP chip can be used to control the LNA 117 power, thereby enabling the LNA 117 to be powered down and powered up in accordance with a control algorithm.

In one embodiment, the signal filter 119 is defined as an L-Band device, such as a Surface Acoustic Wave (SAW) filter. For example, in one embodiment, the signal filter 119 is implemented as a model B39162B3520U410 SAW filter manufactured by EPCOS Inc. As previously stated, an output of the signal filter 119 is connected to an RF input of the LDD 111, as indicated by arrow 157. In one embodiment, a 50 ohm micro-strip trace on the printed circuit board of the TAG 100 is used to connect the output of the signal filter 119 to the RF input of the LDD 111. Also, in one embodiment, the signal filter 119 is tuned to pass RF signals at 1575 MHz to the RF input of the LDD 111.

The TAG 100 also includes a data interface 123 defined to enable electrical connection of various external devices to the LDD 111 and chip 101 of the TAG 100. For example, in one embodiment, the chip 101 includes a number of reconfigurable general purpose interfaces that are electrically connected to respective pins of the data interface 123. Thus, in this embodiment, an external device (such as a sensor for commercial and/or security applications) can be electrically connected to communicate with the chip 101 through the data interface 123, as indicated by arrow 169. The LDD 111 is also connected to the data interface 123 to enable electrical communication between an external entity and the LDD 111, as indicated by arrow 167. For example, an external entity may be connected to the LDD 111 through the data interface 123 to program the LDD 111. It should be appreciated that the data interface 123 can be defined in different ways in various embodiments. For example, in one embodiment, the data interface 123 is defined as a serial interface including a number of pins to which an external device may connect. In other example, the data interface may be defined as a USB interface, among others.

The TAG 100 also includes an extended memory 135 connected to the processor 103 of the chip 101, as indicated by arrow 175. The extended memory 135 is defined as a non-volatile memory that can be accessed by the processor 103 for data storage and retrieval. In one embodiment, the extended memory 135 is defined as a solid-state non-volatile memory, such as a flash memory. The extended memory 135 can be defined to provide segmented non-volatile storage, and can be controlled by the software executed on the processor 103. In one embodiment, separate blocks of memory within the extended memory 135 can be allocated for dedicated use by either security applications or commercial applications. In one embodiment, the extended memory 135 is a model M25P10-A flash memory manufactured by ST Microelectronics. In another embodiment, the extended memory 135 is a model M25PE20 flash memory manufactured by Numonyx. It should be understood that in other embodiments, many other different types of extended memory 135 may be utilized so long as the extended memory 135 can be operably interfaced with the processor 103.

The TAG 100 also includes a motion sensor 133 in electrical communication with the chip 101, i.e., with the processor 103, as indicated by arrow 173. The motion sensor 133 is defined to detect physical movement of the TAG 100, and thereby detect physical movement of the asset to which the TAG 100 is affixed. The processor 103 is defined to receive motion detection signals from the motion sensor 133, and based on the received motion detection signals determine an appropriate mode of operation for the TAG 100. Many different types of motion sensors 133 may be utilized in various embodiments. For example, in some embodiments, the motion sensor 133 may be defined as an accelerometer, a gyro, a mercury switch, a micro-pendulum, among other types. Also, in one embodiment, the TAG 100 may be equipped with multiple motion sensors 133 in electrical communication with the chip 101. Use of multiple motion sensors 133 may be implemented to provide redundancy and/or diversity in sensing technology/stimuli. For example, in one embodiment, the motion sensor 133 is a model ADXL330 motion sensor manufactured by Analog Devices. In another exemplary embodiment, the motion sensor 133 is a model ADXL311 accelerometer manufactured by Analog Devices. In yet another embodiment, the motion sensor 133 is a model ADXRS50 gyro manufactured by Analog Devices.

The TAG 100 also includes a voltage regulator 187 connected to the power source 143. The voltage regulator 187 is defined to provide a minimum power dropout when the power source 143 is implemented as a battery. The voltage regulator 187 is further defined to provide optimized voltage control and regulation to the powered components of the TAG 100. In one embodiment, a capacitive filter is connected at the output of the voltage regulator 187 to work in conjunction with a tuned bypass circuit between the power plane of the TAG 100 and a ground potential, so as to minimize noise and RF coupling with the LNA's 117 and 137 of the LDD 111 and radio 105, respectively.

Also, in one embodiment, the radio 105 and LDD 111 are connected to receive common reset and brown out protection signals from the voltage regulator 187 to synchronize TAG 100 startup and to protect against executing corrupted memory (115/104) during a slow ramping power up or during power source 143, e.g., battery, brown out. In one exemplary embodiment, the voltage regulator 187 is a model TPS77930 voltage regulator manufactured by Texas Instruments. In another exemplary embodiment, the voltage regulator 187 is a model TPS77901 voltage regulator manufactured by Texas Instruments. It should be appreciated that different types of voltage regulator 187 may be utilized in other embodiments, so long as the voltage regulator is defined to provide optimized voltage control and regulation to the powered components of the TAG 100.

To enable long-term TAG 100 deployment with minimal maintenance, the processor 103 of the chip 101 is operated to execute a power management program for the TAG 100. The power management program controls the supply of power to various components within the TAG 100, most notably to the LDD 111 and radio 105. The TAG 100 has four primary power states:

1) LDD 111 Off and radio 105 Off,

2) LDD 111 Off and radio 105 On,

3) LDD 111 On and radio 105 Off, and

4) LDD 111 On and radio 105 On.

The power management program is defined such that a normal operating state of the TAG 100 is a sleep mode in which both the LDD 111 and radio 105 are powered off. The power management program is defined to power on the LDD 111 and/or radio 105 in response to events, such as monitored conditions, external stimuli, and pre-programmed settings. For example, a movement event or movement temporal record, as detected by the motion sensor 133 and communicated to the processor 103, may be used as an event to cause either or both of the LDD 111 and radio 105 to be powered up from sleep mode. In another example, a pre-programmed schedule may be used to trigger power up of either or both of the LDD 111 and radio 105 from sleep mode. Additionally, other events such as receipt of a communications request, external sensor data, geolocation, or combination thereof, may serve as triggers to power up either or both of the LDD 111 and radio 105 from sleep mode.

The power management program is also defined to power down the TAG 100 components as soon as possible following completion of any requested or required operations. Depending on the operations being performed, the power management program may direct either of the LDD 111 or radio 105 to power down while the other continues to operate. Or, the operational conditions may permit the power management program to simultaneously power down both the LDD 111 and radio 105. As previously mentioned, in one embodiment, the power management system is defined to enable TAG 100 operation for over three years on a single 3 Volt battery, such as a 3 Volt D-cell battery.

To support the power management program, the TAG 100 utilizes four separate crystal oscillators. Specifically, with reference to FIG. 2, the chip 101 utilizes a 32 MHz (megaHertz) oscillator 125 to provide a base operational clock for the chip 101, as indicated by arrow 149. The chip 101 also utilizes a 32 kHz (kiloHertz) ° oscillator 127 to provide a real-time clock for wakeup of the chip 101 from the sleep mode of operation, as indicated by arrow 151. The LDD 111 utilizes a 24 MHz oscillator 129 to provide a base operational clock for the LDD 111, as indicated by arrow 147. Also, the LDD 111 utilizes a 32 kHz oscillator 131 to provide a real-time clock for wakeup of the LDD 111 from the sleep mode of operation, as indicated by arrow 145. It should be understood, however, that in other embodiments, other oscillator arrangements may be utilized to provide the necessary clocking for the chip 101 and LDD 111. For example, crystal oscillators of different frequency may be used, depending on the operational requirements of the LDD 111 and chip 101.

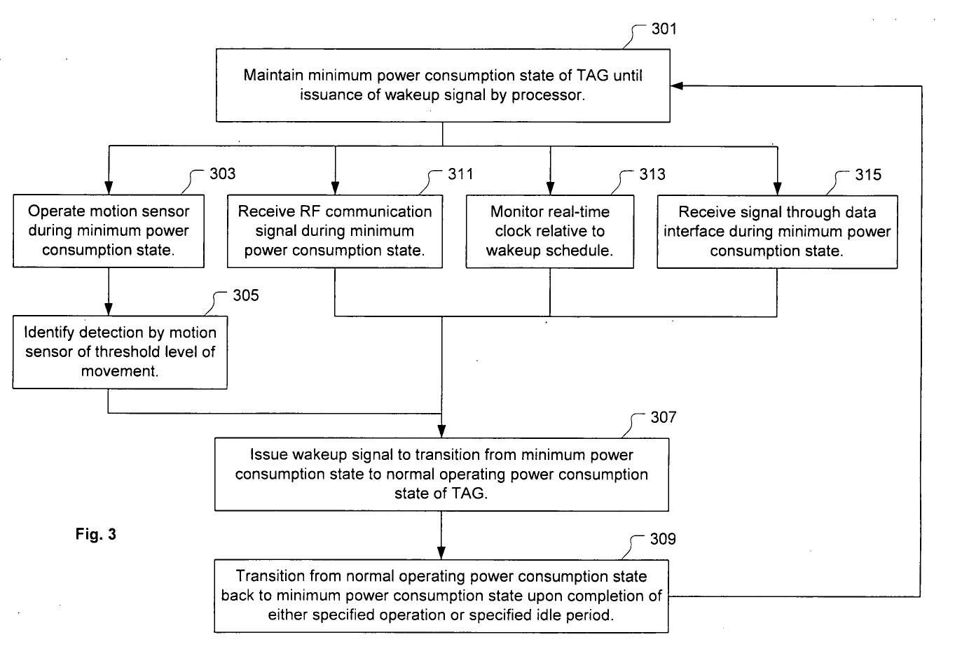

FIG. 3 is an illustration showing a flowchart of a method for operating a radiofrequency tracking and communication device, i.e., TAG 100, in accordance with one embodiment of the present invention. The method of FIG. 3 represents an example of how the power management program can be implemented within the TAG 100. The method includes an operation 301 for maintaining a minimum power consumption state of the TAG 100 until issuance of a wakeup signal by the processor 103. As mentioned above, the minimum power consumption state of the TAG 100 exists when both the LDD 111 and the radio 105 are powered off.

The method also includes an operation 303 for operating the motion sensor 133 during the minimum power consumption state. The method further includes an operation 305 for identifying detection by the motion sensor 133 of a threshold level of movement. It should be understood that because the motion sensor 133 is disposed onboard the TAG 100, the threshold level of movement detected by the motion sensor 133 corresponds to movement of the TAG 100, and the asset to which the TAG 100 is affixed.

In one embodiment, the threshold level of movement is defined as a single motion detection signal of at least a specified magnitude. In this embodiment, the processor 103 is defined to receive the motion detection signal from the motion sensor 133 and determine whether the received motion detection signal exceeds a specified magnitude as stored in the memory 104. In another embodiment, the threshold level of movement is defined as an integral of motion detection signals having reached at least a specified magnitude. In this embodiment, motion detection signals are received and stored by the processor 103 over a period of time. The processor 103 determines whether or not the integral, i.e., sum, of the received motion detection signals over the period of time has reached or exceeded a specified magnitude as stored in the memory 104. Additionally, the two embodiments regarding the threshold level of movement as disclosed above may be implemented in a combined manner.

In response to identifying that the threshold level of movement has been reached or exceeded, the method includes an operation 307 for issuing the wakeup signal to transition from the minimum power consumption state to a normal operating power consumption state of the TAG 100. The wakeup signal is generated by the processor 103, upon recognition by the processor 103 that the threshold level of movement has been reached or exceeded. The processor 103 can be operated to transmit the wakeup signal to either or both the LDD 111 and radio 105, depending on an operation sequence to be performed upon reaching the threshold level of movement. The method also includes an operation 309 in which the TAG 100 is transitioned from the normal operating power consumption state back to the minimum power consumption state upon completion of either a specified operation or a specified idle period by the TAG 100.

With reference back to operation 301, the method may proceed with an operation 311 in which an RF communication signal is received during the minimum power consumption state. In response to receiving the RF communication signal, the method proceeds with the operation 307 for issuing the wakeup signal to transition the TAG 100 from the minimum power consumption state to the normal operating power consumption state. Again, the wakeup signal is generated by the processor 103, and may direct the radio 105, LDD 111, or both to power up, depending on the content of the received RF communication signal.

Also, with reference back to operation 301, the method may proceed with an operation 313 for monitoring a real-time clock relative to a wakeup schedule. In one embodiment, the monitoring of the real-time clock relative to the wakeup schedule is performed by the processor 103 while the TAG 100 is in the minimum power consumption state. Upon reaching a specified wakeup time in the wakeup schedule, the method proceeds with operation 307 to issue the wakeup signal to transition the TAG 100 from the minimum power consumption state to the normal operating power consumption state.

With reference back to operation 301, the method may proceed with an operation 315 for receiving a signal through the data interface 123 during the minimum power consumption state. In one embodiment, the signal received through the data interface 123 may be a data signal generated by an external device connected to the data interface 123. For example, a sensor may be connected to the data interface 123, and may transmit a data signal indicative of a monitored alarm or condition that triggers the processor 103 to generate a wakeup signal to power up either or both of the LDD 111 and radio 105. For example, the data signal may be a push button signal, an intrusion alarm signal, a chemical/biological agent detection signal, a temperature signal, a humidity signal, or essentially any other type of signal that may be generated by a sensing device.

Additionally, a user may connect a computing device, such as a handheld computing device or laptop computer, to the data interface 123 to communicate with the LDD 111 or processor 103. In one embodiment, connection of the computing device to the data interface 123 will cause the processor 103 to generate a wakeup signal to power up either or both of the LDD 111 and radio 105. In response to receiving the signal through the data interface 123 in operation 315, the method proceeds with the operation 307 for issuing the wakeup signal to transition the TAG 100 from the minimum power consumption state to the normal operating power consumption state. Again, in operation 307, the wakeup signal is generated by the processor 103, and may direct the radio 105, LDD 111, or both to power up, depending on the type of signal received through the data interface 123.

An inductive loop is integrated into the TAG 100 to provide for RF impedance matching between the various RF portions of the TAG 100. In one embodiment, the inductive loop is tuned to provide a 0.5 nH (nanoHertz) reactive load over a wavelength trace. In one embodiment, the impedance match between the RF output from the radio 105 and the RX/TX switch 139 is 50 ohms. Also, the RF power amplifier 107 is capacitively coupled with the RX/TX switch 141. Additionally, in one embodiment, to provide for decoupling of the power source 143 from the radio 105, eight high frequency ceramic capacitors are tied between the power pins of the chip 101 and the ground potential of the TAG 100.

In one embodiment, a power plane of the chip 101 is defined as a split independent inner power plane that is DC-coupled with the LDD 111 power plane through an RF choke and capacitive filter. In this embodiment, noise from a phase lock loop circuit within the radio 105 will not couple via the inner power plane of the chip 101 to the power plane of the LDD 111. In this manner, radio harmonics associated with operation of the radio 105 are prevented from significantly coupling with the LDD 111 during simultaneous operation of the both the radio 105 and LDD 111, thereby maintaining LDD 111 sensitivity.

An impedance matching circuit is also provided to ensure that the RF signal can be received by the LDD 111 without substantial signal loss. More specifically, the RF input to the LDD 111 utilizes an impedance matching circuit tuned for dielectric properties of the TAG 100 circuit board. In one embodiment, the connection from the LDD antenna 121 to the LNA 117 is DC-isolated from the RF input at the LNA 117 using a 100 pf (picofarad) capacitor, and is impedance matched to 50 ohms. Also, in one embodiment, the output of the LNA 117 is impedance matched to 50 ohms.

While this invention has been described in terms of several embodiments, it will be appreciated that those skilled in the art upon reading the preceding specifications and studying the drawings will realize various alterations, additions, permutations and equivalents thereof. Therefore, it is intended that the present invention includes all such alterations, additions, permutations, and equivalents as fall within the true spirit and scope of the invention.

What is claimed is:

1. A radiofrequency tracking and communication device, comprising:
a processor defined on a chip;
a radio defined on the chip to electrically communicate with the processor, wherein the radio is defined to operate at an international frequency, and wherein the radio is defined to be powered on and off in accordance with a control signal to be transmitted by the processor;
a location determination device defined to electrically communicate with the processor, wherein the location determination device is defined to be powered on and off in accordance with a control signal to be transmitted by the processor; and
a power source defined to supply power to the processor, the radio, and the location determination device.

2. A radiofrequency tracking and communication device as recited in claim 1, wherein the radio is defined in compliance with an Institute of Electrical and Electronics Engineers (IEEE) 802.15.4 standard.

3. A radiofrequency tracking and communication device as recited in claim 1, wherein the location determination device is a global positioning system (GPS) receiving device.

4. A radiofrequency tracking and communication device as recited in claim 1, further comprising:
a first antenna defined to receive radiofrequency (RF) signals;
a first low noise amplifier connected to receive RF signals from the first antenna; and
a signal filter connected to receive RF signals from the first low noise amplifier, the signal filter connected to transmit processed RF signals to the location determination device.

5. A radiofrequency tracking and communication device as recited in claim 4, wherein the first low noise amplifier is connected to receive a power control signal from the location determination device, wherein the first low noise amplifier is defined to be powered on and off in accordance with the power control signal to be received from the location determination device.

6. A radiofrequency tracking and communication device as recited in claim 4, wherein the signal filter is a surface acoustic wave (SAW) signal filter.

7. A radiofrequency tracking and communication device as recited in claim 1, further comprising:
a radio antenna defined to receive and transmit radiofrequency (RF) signals;
an RF signal transmission path defined to extend from the radio to the radio antenna;
an RF signal reception path defined to extend from the radio antenna to the radio; and
a pair of RF switches defined to operate in a cooperative manner so as to enable either the RF signal transmission path or the RF signal reception path at a given time.

8. A radiofrequency tracking and communication device as recited in claim 7, further comprising:
a power amplifier connected between the pair of RF switches in the RF signal transmission path; and
a low noise amplifier connected between the pair of RF switches in the RF signal reception path.

9. A radiofrequency tracking and communication device as recited in claim 8, further comprising:
a control circuit defined to direct cooperative operation of the pair of RF switches and to direct power control of the power amplifier and low noise amplifier, wherein the control circuit is defined to receive a control signal from the processor, and in accordance with the control signal direct the pair of RF switches to establish continuity along either the RF signal transmission path or along the RF signal reception path.

10. A radiofrequency tracking and communication device as recited in claim 1, further comprising:
a first crystal oscillator connected to provide a first operational clock signal to the chip when the chip is in a normal operation mode;
a second crystal oscillator connected to provide a first real-time clock signal to the chip during all modes of chip operation;
a third crystal oscillator connected to provide a second operational clock signal to the location determination device when the location determination device is in a normal operation mode; and
a fourth crystal oscillator connected to provide a second real-time clock signal to the location determination device during all modes of location determination device operation.

11. A radiofrequency tracking and communication device as recited in claim 10, wherein the first crystal oscillator is defined to generate a 32 megaHertz (MHz) clock signal, and wherein the third crystal oscillator is defined to generate a 24 MHz clock signal, and wherein each of the second and fourth crystal oscillators is defined to generate a 32 kiloHertz (kHz) clock signal.

12. A radiofrequency tracking and communication device as recited in claim 1, further comprising:
an extended memory connected to the processor, wherein the extended memory is defined as a non-volatile memory accessible by the processor for data storage and retrieval.

13. A radiofrequency tracking and communication device as recited in claim 1, further comprising:
a voltage regulator connected to an output of the power source, wherein the voltage regulator is defined to provide optimized voltage control and regulation to the processor, radio, and location determination device.

14. A radiofrequency tracking and communication device as recited in claim 1, further comprising:
a data interface defined to enable electrical connection of various external devices to the location determination device and chip.

15. A radiofrequency tracking and communication device as recited in claim 1, further comprising:
a motion sensor in electrical communication with the processor, wherein the motion sensor is defined to detect physical movement of the radiofrequency tracking and communication device and transmit corresponding motion detection signals to the processor.

16. A radiofrequency tracking and communication device, comprising:
a processor defined on a chip;
a radio defined on the chip to electrically communicate with the processor, wherein the radio is defined in compliance with an Institute of Electrical and Electronics Engineers (IEEE) 802.15.4 standard;
a global positioning system (GPS) receiving device defined to electrically communicate with the processor; and
a power source defined to supply power to the processor, the radio, and the GPS receiving device.

17. A radiofrequency tracking and communication device as recited in claim 16, wherein each of the radio and GPS receiving device is defined to be independently powered on and off in accordance with respective control signals to be transmitted by the processor.

18. A radiofrequency tracking and communication device as recited in claim 16, further comprising:
a motion sensor in electrical communication with the processor, wherein the motion sensor is defined to detect physical movement of the radiofrequency tracking and communication device and transmit corresponding motion detection signals to the processor.

19. A radiofrequency tracking and communication device as recited in claim 18, wherein the processor is defined to receive motion detection signals from the motion sensor and based on the received motion detection signals determine an appropriate mode of operation for the radiofrequency tracking and communication device.

20. A radiofrequency tracking and communication device as recited in claim 18, wherein the motion sensor is defined as either an accelerometer, a gyro, a mercury switch, a micro-pendulum, or a combination thereof.

21. A method for operating a radiofrequency tracking and communication device, comprising:
maintaining a minimum power consumption state of the radiofrequency tracking and communication device until issuance of a wakeup signal;
operating a motion sensor during the minimum power consumption state;
identifying detection by the motion sensor of a threshold level of movement; and
in response to identifying the threshold level of movement, issuing the wakeup signal to transition from the minimum power consumption state to a normal operating power consumption state of the radiofrequency tracking and communication device.

22. A method for operating a radiofrequency tracking and communication device as recited in claim 21, wherein the threshold level of movement is defined as a single motion detection signal of at least a first specified magnitude, or as an integral of motion detection signals having reached at least a second specified magnitude, or a combination thereof.

23. A method for operating a radiofrequency tracking and communication device as recited in claim 21, further comprising:
transitioning from the normal operating power consumption state to the minimum power consumption state of the radiofrequency tracking and communication device upon completion of either a specified operation or a specified idle period by the radiofrequency tracking and communication device.

24. A method for operating a radiofrequency tracking and communication device as recited in claim 21, further comprising:
receiving a radiofrequency (RF) communication signal during the minimum power consumption state; and
in response to receiving the RF communication signal, issuing the wakeup signal to transition from the minimum power consumption state to the normal operating power consumption state of the radiofrequency tracking and communication device.

25. A method for operating a radiofrequency tracking and communication device as recited in claim 21, further comprising:
monitoring a real-time clock relative to a wakeup schedule; and
upon reaching a specified wakeup time in the wakeup schedule, issuing the wakeup signal to transition from the minimum power consumption state to the normal operating power consumption state of the radiofrequency tracking and communication device.
